(19) United States
(12) Patent Application Publication
(10) Pub. No.: US 2024/0394457 A1
(43) Pub. Date: Nov. 28, 2024

(54) SEMICONDUCTOR DESIGN ASSISTANCE DEVICE, SEMICONDUCTOR DESIGN ASSISTANCE METHOD, AND NON-TRANSITORY COMPUTER READABLE MEDIUM

(71) Applicant: Mitsubishi Electric Corporation, Tokyo (JP)

(72) Inventors: Shunsuke TATSUMI, Tokyo (JP); Ryo YAMAMOTO, Tokyo (JP)

(73) Assignee: Mitsubishi Electric Corporation, Tokyo (JP)

(21) Appl. No.: 18/795,427

(22) Filed: Aug. 6, 2024

Related U.S. Application Data
(63) Continuation of application No. PCT/JP2022/013170, filed on Mar. 22, 2022.

(51) Int. Cl. G06F 30/392

(52) U.S. Cl. CPC G06F 30/392

(57) ABSTRACT

A semiconductor design assistance device (100) includes an interface specification formulation unit (120) to refer to input/output information that indicates definitions of an access pattern and throughput for each input and each output of each of two functions, and formulate a specification of an interface part that transmits data between the two functions, based on source code indicating the two functions and a data flow between the two functions indicated in the source code, where in each of the two functions, when data is exchanged between two circuit modules, processing to be performed by a corresponding one of the two circuit modules is defined in a language that can define an input to and an output from a function.

### CROSS REFERENCE TO RELATED APPLICATIONS

This application is a Continuation of PCT International Application No. PCT/JP2022/013170, filed on Mar. 22, 2022, which is hereby expressly incorporated by reference into the present application.

### TECHNICAL FIELD

The present disclosure relates to a semiconductor design assistance device, a semiconductor design assistance method, and semiconductor design assistance.

### BACKGROUND ART

In recent years, circuits have become larger in scale, and in order to handle large-scale circuits, research is progressing into high-level synthesis that automatically generates circuits using a language with a higher level of abstraction (C++, etc.) than a hardware description language (Very High Speed Integrated Circuit (VHSIC) Program hardware description language (VHDL), etc.).

Conventionally, there is a problem in high-level synthesis that when there is a dependency between array variables handled by two processes, one of the processes cannot start processing until a write to an array variable handled by the other one of the processes is completed.

As means for solving this problem, Patent Literature 1 discloses a technology to analyze variables exchanged between processes by referring to source code, create a first in, first out (FIFO) buffer or a ping-pong buffer for holding the analyzed variables, and automatically generate a data-driven circuit based on a signal indicating full or empty. According to this technology, a circuit that allows the processes to operate in parallel is automatically generated.

### CITATION LIST

### Non-Patent Literature

Non-Patent Literature 1: “Vitis High-Level Synthesis User Guide”, Xilinx, Inc., v2021.1, August 2021

### SUMMARY OF INVENTION

### Technical Problem

In the technology disclosed in Non-Patent Literature 1, if access patterns of variables exchanged between processes are simple and thus the variables can be analyzed relatively easily, data can be transferred using a FIFO buffer with a relatively small amount of memory. However, in this technology, if the access patterns are not simple and thus the variables cannot be analyzed, data is transferred by a ping-pong buffer using the amount of memory that is twice the array size. Therefore, a problem of this technology is that when the access patterns of variables exchanged between processes are not simple, the amount of memory used by an interface part that transmits data between the processes becomes larger than necessary.

An object of the present disclosure is to make the amount of memory used by an interface part that transmits data between processes relatively small when access patterns of variables exchanged between the processes are not simple in high-level synthesis.

### Solution to Problem

A semiconductor design assistance device according to the present disclosure includes an interface specification formulation unit to refer to input/output information that indicates definitions of an access pattern and throughput for each input and each output of each of two functions, and formulate a specification of an interface part that transmits data between the two functions, based on source code that indicates the two functions and a data flow between the two functions indicated in the source code, the two functions being functions in each of which, when data is exchanged between two circuit modules, processing to be performed by a corresponding one of the two circuit modules is defined in a language that can define an input to and an output from a function.

### Advantageous Effects of Invention

According to the present disclosure, an interface specification formulation unit refers to input/output information that indicates an access pattern and throughput of each input and each output of each of two functions, and formulates a specification of an interface part that transmits data between the two functions. Therefore, according to the present disclosure, it is possible to make the amount of memory used by an interface part that transmits data between processes relatively small when access patterns of variables exchanged between the processes are not simple in high-level synthesis.

### BRIEF DESCRIPTION OF DRAWINGS

FIG. 1 is a figure illustrating an example of a configuration of a semiconductor design assistance device 100 according to Embodiment 1;

FIG. 2 is a figure describing processing by a data flow analysis unit 110 according to Embodiment 1;

FIG. 3 is a figure describing an IF part according to Embodiment 1;

FIG. 4 is a figure illustrating a specific example of a function library 121 according to Embodiment 1;

FIG. 5 is a figure describing processing by an IF generation unit 130 according to Embodiment 1;

FIG. 6 is a figure illustrating an example of a hardware configuration of the semiconductor design assistance device 100 according to Embodiment 1;

FIG. 7 is a flowchart illustrating operation of an IF specification formulation unit 120 according to Embodiment 1;

FIG. 8 is a figure describing processing by the IF specification formulation unit 120 according to Embodiment 1;

FIG. 9 is a figure describing processing by the IF specification formulation unit 120 according to Embodiment 1;

FIG. 10 is a figure describing processing by the IF specification formulation unit 120 according to Embodiment 1;

FIG. 11 is a figure describing a window buffer;

FIG. 12 is a figure describing a ping-pong buffer; and

FIG. 13 is a figure illustrating an example of a hardware configuration of the semiconductor design assistance device 100 according to a variation of Embodiment 1.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in figures mainly indicate flows of data or flows of processing. “Unit” may be suitably interpreted as “circuit”, “step”, “procedure”, “process”, or “circuitry”.

### Embodiment 1

This embodiment will be described in detail below with reference to the drawings.

### DESCRIPTION OF CONFIGURATION

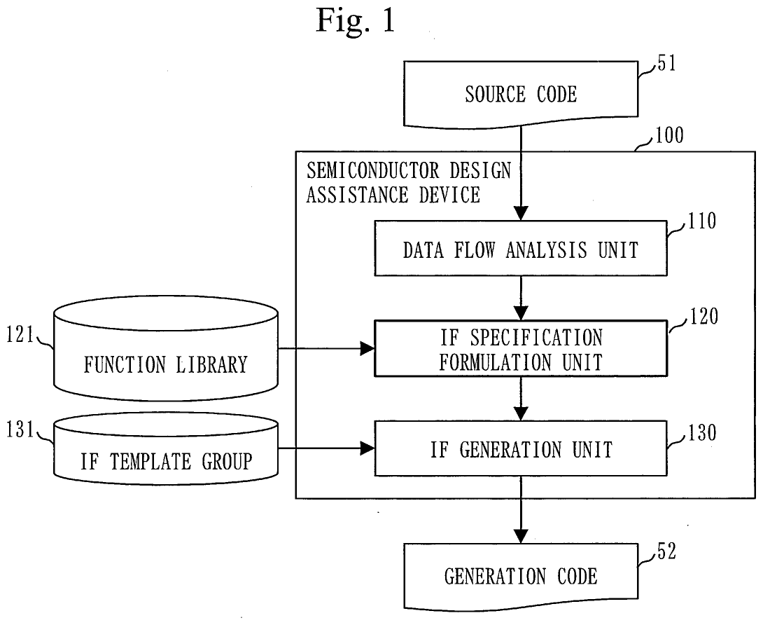

FIG. 1 illustrates an example of a configuration of a semiconductor design assistance device 100 according to this embodiment. As illustrated in this figure, the semiconductor design assistance device 100 includes a data flow analysis unit 110, an IF specification formulation unit 120, and an interface (IF) generation unit 130. The semiconductor design assistance device 100 may refer to a function library 121 and an IF template group 131 that are located externally, or may store the function library 121 and the IF template group 131.

The data flow analysis unit 110 receives source code 51, and analyzes data flows indicated by the received source code 51. A data flow is an exchange of data between functions. That is, the data flow analysis unit 110 analyzes how data is transferred between functions.

The source code 51 describes the operation of a circuit in a high-level language such as the C language or C++. The source code 51 may be written in any language that can define inputs to and outputs from functions. In the source code 51, each process is defined as a function. That is, when data is exchanged between two circuit modules included in a circuit, two functions respectively corresponding to the two circuit modules are defined in a language that can define inputs to and outputs from functions in the source code 51. The two functions may be selected in any way from the functions included in the source code 51. Each of the two functions represents processing performed by a corresponding one of the two circuit modules.

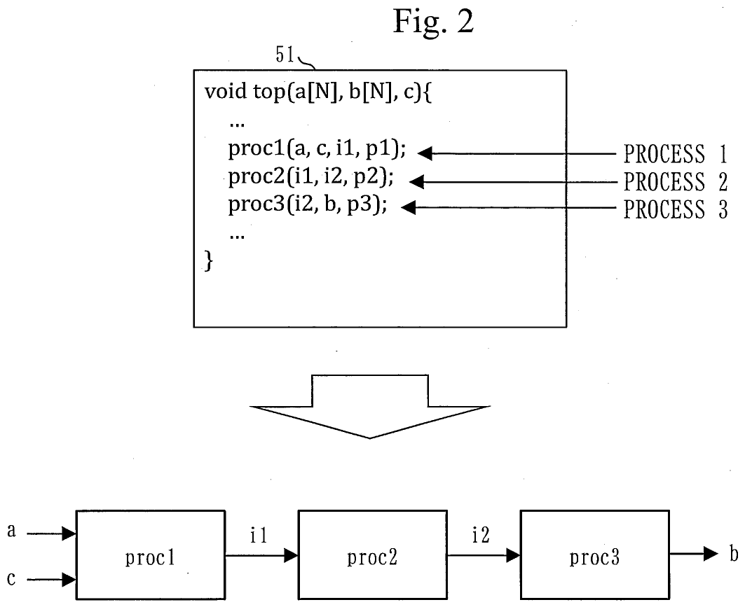

FIG. 2 is a figure describing processing by the data flow analysis unit 110. FIG. 2 illustrates a specific example of the source code 51, and three processes of a process 1 to a process 3 are described using functions in the source code 51. In addition, a result of analyzing the data flows in the source code 51 by the data flow analysis unit 110 is indicated in the lower side of FIG. 2. A process indicates processing executed by a circuit module.

The IF specification formulation unit 120 refers to input/output information indicated in the function library 121, and formulates a specification of an IF part between the two functions, based on the source code 51 and the data flow between the two functions analyzed by the data flow analysis unit 110. The input/output information is auxiliary information regarding an input to and an output from each function, and is information indicating definitions of an access pattern and throughput regarding an input to and an output from each function that may be included in the source code 51. At this time, the IF specification formulation unit 120 determines an architecture of the IF part. The data flow analysis unit 110 formulates the specification of the IF part starting from the first process in a data flow graph and working sequentially downward.

When out of two functions, a function defined to be executed earlier in the source code 51 is defined as a preceding function and a function defined to be executed later in the source code 51 is defined as a succeeding function, the IF specification formulation unit 120 may determine the architecture of the IF part based on an output order of a target array indicated by the preceding function and an input order of the target array indicated by the succeeding function. The IF specification formulation unit 120 determines the amount of memory of the IF part based on the source code 51 and the input/output information.

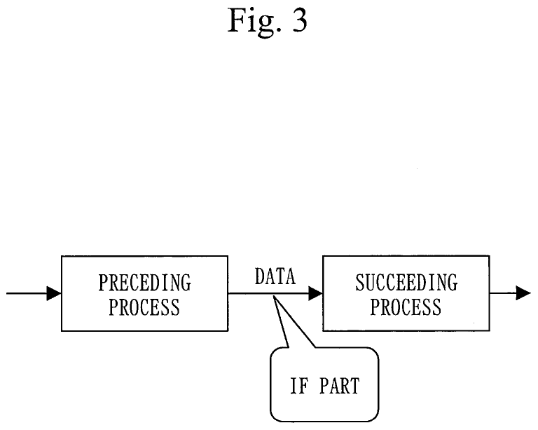

The IF part is a part that connects processes and also transmits data between two functions. FIG. 3 is a figure describing the IF part. As indicated in FIG. 3, the IF part manages the input and output of data between one process and a process executed immediately after this one process.

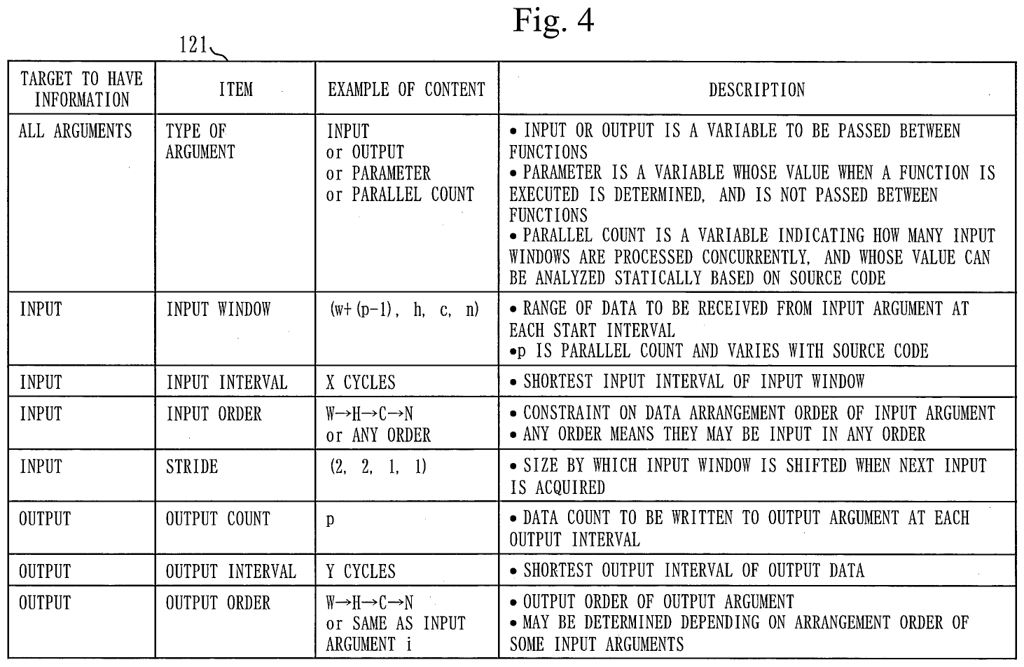

The function library 121 indicates input/output information for each function. FIG. 4 illustrates a specific example of the input/output information indicated by the function library 121.

By utilizing the input/output information that is highly abstract, the IF specification formulation unit 120 can implement the IF part as a data-driven circuit. In addition to the input/output information, the function library 121 includes a definition file at register-transfer level (RTL), in a high-level language, or the like, and the definition file indicates processing details of each function included in the source code 51. The input/output information may include at least one unfixed item. An unfixed item is an item that cannot be fixed unless the source code 51 is given and is not fixedly defined in the input/output information in the function library 121. A specific value or the like of an unfixed item is not fixed until the source code 51 is given. As a specific example, unfixed items include a parallel count, an input order, and an output order. The IF specification formulation unit 120 may fix each of at least one unfixed item based on the source code 51.

The IF generation unit 130 generates generation code 52 based on the specification formulated by the IF specification formulation unit 120 and a template included in the IF template group 131.

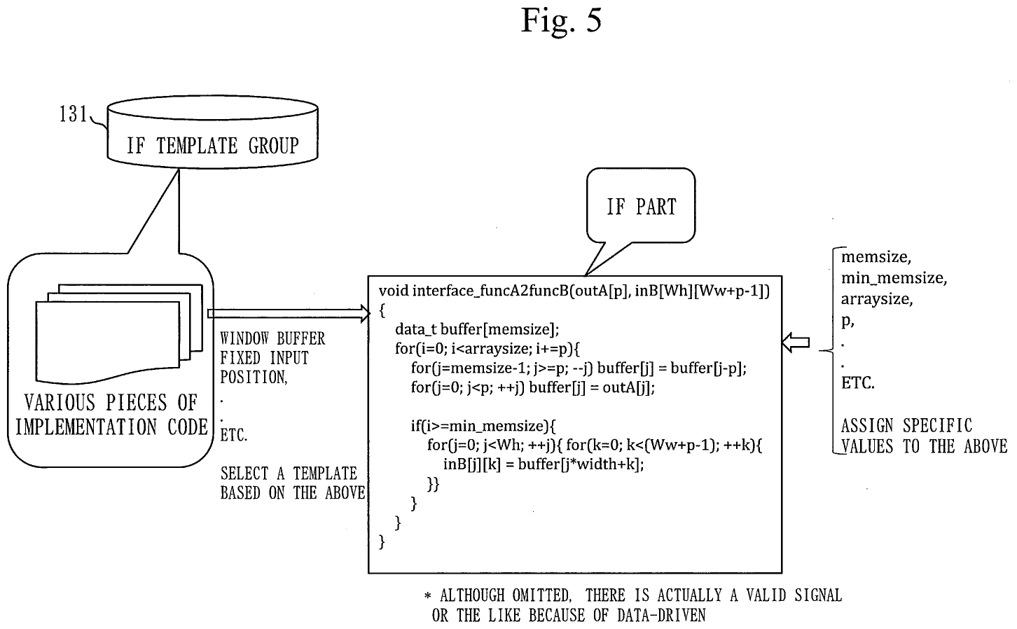

FIG. 5 is a figure describing processing by the IF generation unit 130. FIG. 5 illustrates how the IF generation unit 130 automatically generates source code that represents the IF part.

Specifically, the IF generation unit 130 first selects a template from the IF template group 131 according to the architecture determined by the IF specification formulation unit 120. Next, the IF generation unit 130 generates the source code that represents the IF part by applying the amount of memory determined by the IF specification formulation unit 120, the information indicated by the input/output information, and so on to the selected template. Note that the processing in each function is defined in the function library 121 as an operation part, and the IF generation unit 130 generates a part in which data transfer and data supply are defined as the IF part. Note that a valid signal indicated in FIG. 5 is a signal that conveys whether a signal is valid.

The IF template group 131 includes at least one template for implementation code that represents the IF part. In the IF template group 131, implementation code to be used as a base is provided for each architecture. The IF generation unit 130 typically generates the source code that represents the IF part in the same language as the language of the source code 51, based on a template included in the IF template group 131 and the specification of the IF part.

The generation code 52 is code obtained by adding the IF part to the source code 51. By inputting the generation code 52 into a high-level synthesis tool, a hardware description language that includes the IF part designed so that all processes operate in parallel as much as possible is generated. As a specific example, the generation code 52 corresponds to a general data-driven circuit.

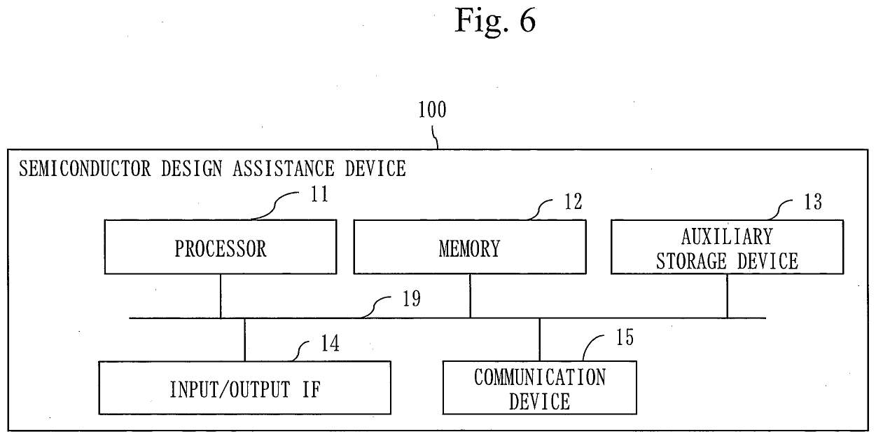

FIG. 6 illustrates an example of a hardware configuration of the semiconductor design assistance device 100 according to this embodiment. The semiconductor design assistance device 100 is composed of a computer. The semiconductor design assistance device 100 may be composed of a plurality of computers.

As illustrated in this figure, the semiconductor design assistance device 100 is a computer that includes hardware components such as a processor 11, a memory 12, an auxiliary storage device 13, an input/output interface (IF) 14, and a communication device 15. These hardware components are connected as appropriate through a signal line 19.

The processor 11 is an integrated circuit (IC) that performs operational processing, and controls the hardware included in the computer. The processor 11 is, as a specific example, a central processing unit (CPU), a digital signal processor (DSP), or a graphics processing unit (GPU).

The semiconductor design assistance device 100 may include a plurality of processors as an alternative to the processor 11. The plurality of processors share the role of the processor 11.

The memory 12 is, typically, a volatile storage device and is, as a specific example, a random access memory (RAM). The memory 12 is also called a main storage device or a main memory. Data stored in the memory 12 is saved in the auxiliary storage device 13 as necessary.

The auxiliary storage device 13 is, typically, a non-volatile storage device and is, as a specific example, a read only memory (ROM), a hard disk drive (HDD), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. The input/output IF 14 is, as a specific example, a Universal Serial Bus (USB) terminal. The input device is, as a specific example, a keyboard and a mouse. The output device is, as a specific example, a display and a printer.

The communication device 15 is a receiver and a transmitter. The communication device 15 is, as a specific example, a communication chip or a network interface card (NIC).

Each unit of the semiconductor design assistance device 100 may use the input/output IF 14 and the communication device 15 as appropriate when communicating with other devices and so on.

The auxiliary storage device 13 stores a semiconductor design assistance program. The semiconductor design assistance program is a program that causes a computer to realize the functions of each unit included in the semiconductor design assistance device 100. The semiconductor design assistance program is loaded into the memory 12 and executed by the processor 11. The functions of each unit included in the semiconductor design assistance device 100 are realized by software.

Data used when the semiconductor design assistance program is executed, data obtained by executing the semiconductor design assistance program, and so on are stored in a storage device as appropriate. Each unit of the semiconductor design assistance device 100 uses the storage device as appropriate. As a specific example, the storage device is composed of at least one of the memory 12, the auxiliary storage device 13, a register in the processor 11, and a cache memory in the processor 11. Data and information may have substantially the same meaning. The storage device may be independent of the computer.

The functions of the memory 12 and the auxiliary storage device 13 may be realized by other storage devices.

The semiconductor design assistance program may be recorded in a computer readable non-volatile recording medium. The non-volatile recording medium is, as a specific example, an optical disc or a flash memory. The semiconductor design assistance program may be provided as a program product.

### DESCRIPTION OF OPERATION

A procedure for the operation of the semiconductor design assistance device 100 is equivalent to a semiconductor design assistance method. A program that realizes the operation of the semiconductor design assistance device 100 is equivalent to the semiconductor design assistance program.

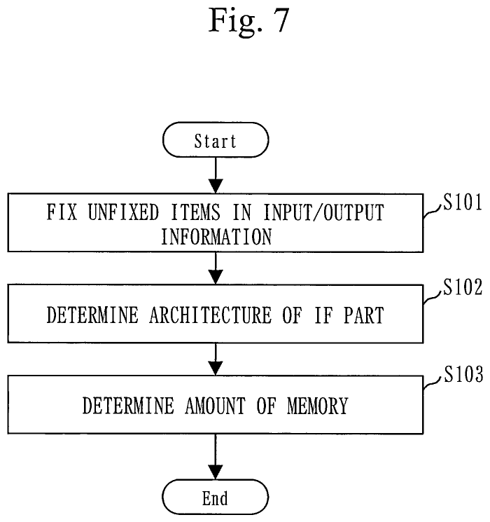

FIG. 7 is a flowchart illustrating an example of processing by the IF specification formulation unit 120. Referring to this figure, the processing by the IF specification formulation unit 120 will be described.

### (Step S101)

The IF specification formulation unit 120 fixes unfixed items based on the source code 51 and data flows.

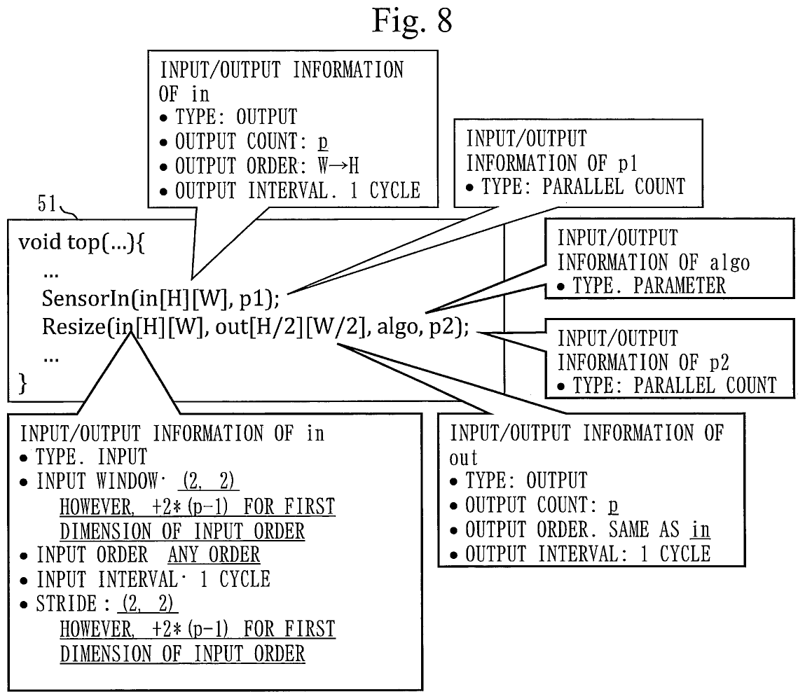

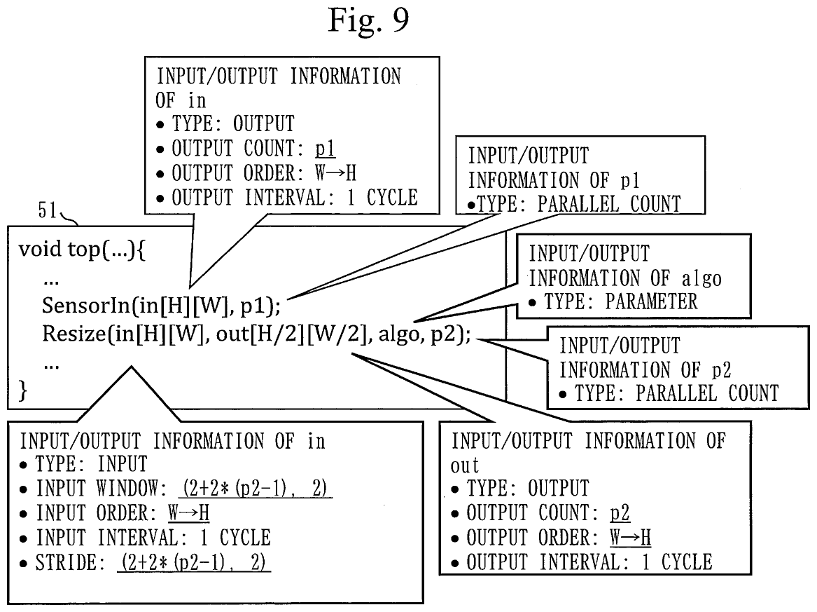

FIGS. 8 and 9 indicate specific examples of processing in this step. FIG. 8 indicates a state in which the unfixed items have not been fixed, and FIG. 9 indicates a state in which the unfixed items have been fixed. Items that are underlined in FIG. 8 are the unfixed items, and the IF specification formulation unit 120 fixes the unfixed items, as indicated in FIG. 9, based on the source code 51 and the data flows.

### (Step S102)

The IF specification formulation unit 120 determines the architecture of the IF part.

Various implementations can be considered as an implementation of the architecture that connects two processes. As a specific example, the IF specification formulation unit 120 selects a window buffer or a ping-pong buffer as the architecture of the IF part, as indicated below.
1. When the input order and the output order are the same: window buffer
2. In other cases: ping-pong buffer

When the IF specification formulation unit 120 selects a window buffer, the IF specification formulation unit 120 determines an input position, as indicated below. The input count is a value obtained by multiplying a stride of the first dimension of an input variable by a parallel count of the following process.
1. When the input count and the output count are the same and the input interval and the output interval are also the same: fixed input position
2. In other cases: any input position

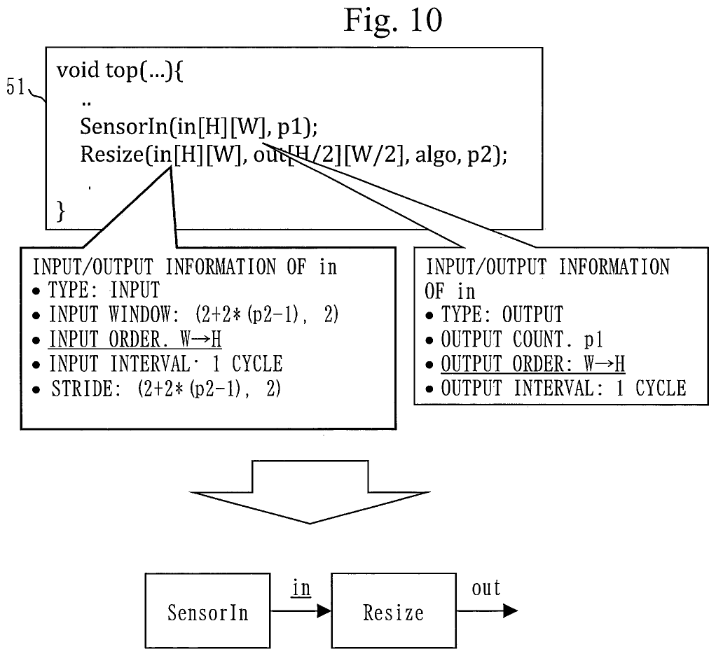

FIG. 10 is a figure describing processing by which the IF specification formulation unit 120 determines the architecture. In a specific example indicated in FIG. 10, the input order and the output order of a variable in are the same, so that the IF specification formulation unit 120 determines the architecture of the IF part that transmits data between a function SensorIn and a function Resize to be a window buffer.

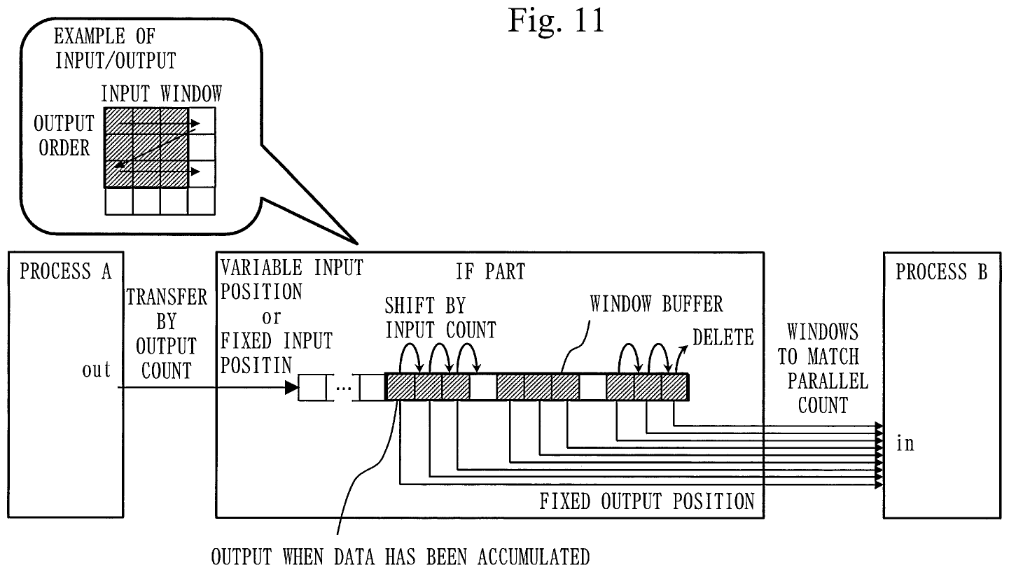

FIG. 11 is a figure describing the window buffer of the IF part. As indicated in FIG. 11, data transferred from a process A by the output count is stored in the window buffer. At this time, the input position is variable or fixed. Then, when a sufficient amount of data has accumulated in the window buffer, the IF part outputs the data stored in the window buffer to a process B.

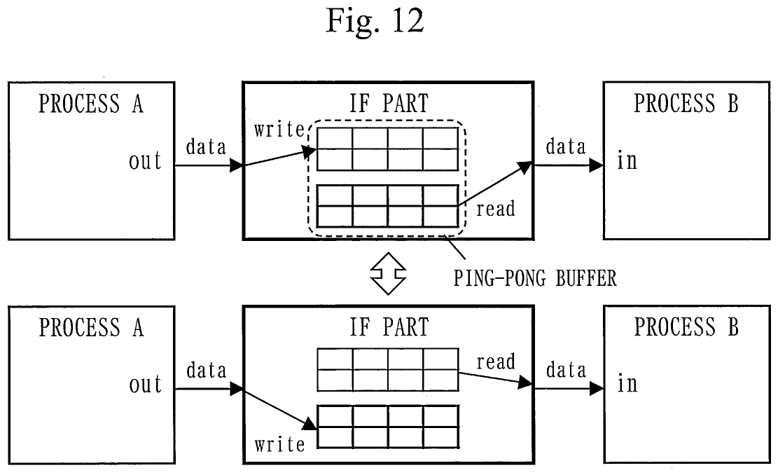

FIG. 12 is a figure describing the ping-pong buffer of the IF part. As indicated in FIG. 12, in the ping-pong buffer provided between the process A and the process B, a write bank and a read bank are switched as appropriate.

### (Step S103)

The IF specification formulation unit 120 calculates the amount of memory of the IF part depending on the architecture of the IF part.

### (Amount of Memory of the Window Buffer)

The IF specification formulation unit 120 calculates the amount of memory of the window buffer, using [Formula 1]. Note that min ( ) is a function that returns the minimum value among arguments. Note that the IF specification formulation unit 120 obtains the array size from the source code 51.

$$Amount of memory = min ( base size + offset size , array size ) \qquad [ Formula 1 ]$$

The base size is the minimum size of the buffer required for data transfer, and is calculated as indicated in [Formula 2].

The minimum memory size is the minimum memory size that is required when the input count is 1, and is calculated as indicated in [Formula 3].

Th offset size is a size of the buffer to fill a difference between the output throughput and the input throughput when the output throughput and the input throughput are different from each other, and is calculated as indicated in [Formula 4]. [Formula 4] corresponds to calculating a difference between the output throughput and the input throughput, and securing the calculated difference as the amount of memory.

Each variable is as described below. Note that the notation of each variable is changed as appropriate to a format that can be expressed in the text of this specification.

dₓ indicates the x-th dimension from the beginning. As a specific example, when the input order is w→h→c→n (the leftmost side indicates the beginning, and it is indicated that access is made sequentially from the beginning), d₁ is w and d₂ is h.

Wₓ indicates the size of dimension x of an input window. As a specific example, when the input window is (w, h, c, n)=(6, 4, 2, 1) and the input order is w→h→c→n, W_{d2} is 4.

Fₓ indicates the size of dimension x of an array. Note that F_{d0} is 1. As a specific example, when the array size is (w, h, c, n)=(64, 32, 128, 16) and the input order is w→h→c→n, F_{d1} is 64.

$$Base size = ⌈ \frac{Minimum memory size}{Input count} ⌉ \times Input count \qquad [ Formula 2 ]$$

$$Minimum memory size = {\sum }_{i = 1}^{Number of dimensions} \{ ( {W}_{{d}_{i}} - 1 ) \times {\prod }_{j = 0}^{j < 1} {F}_{{d}_{j}} \} + 1 \qquad [ Formula 3 ]$$

$$Output throughtput = \frac{Output count}{Output Interval} \qquad [ Formula 4 ]$$

$$Input throughtput = \frac{Input count}{Input Interval}$$

$$When ( output throughtput \leq input throughtput ) : Offset size = 0$$

$$In other cases :$$

$$Offset size = Array size - [ \frac{Number of cycles required for output}{Input interval} ] \times Input count$$

$$Number of cycles required for output = [ \frac{Array size}{Output count} ] \times Output interval$$

### (Amount of Memory of the Ping-Pong Buffer)

First, the IF specification formulation unit 120 calculates the amount of memory of the ping-pong buffer, using [Formula 5]. The number of buffer banks is not limited to two.

$$Amount of memory = Size of one bank \times Number of buffer banks \qquad [ Formula 5 ]$$

$$Number of buffer banks = ⌈ \frac{Size of one bank + Offset size}{Size of one bank} ⌉ + 1 + Switching penalty$$

The offset size here is the same as the offset size of the window buffer.

The switching penalty is a parameter for increasing the number of buffer banks when switching between buffer banks takes time, and is determined depending on the hardware that implements the circuit. Therefore, a user sets the switching penalty in advance.

The size of one bank is a memory size of one buffer bank. Specifically, the IF specification formulation unit 120 calculates the size of one bank by the following procedure.

First, the IF specification formulation unit 120 compares the output order with the input order from the end sequentially, and finds the first dimension where there is a difference between the orders, that is, the rearmost dimension where there is a difference between the orders.

Next, the IF specification formulation unit 120 calculates, as the size of one bank, the amount of memory that can store all array elements indicated by the rearmost dimension where there is a difference between the orders and the dimensions preceding this dimension, using [Formula 6].

$$Size of one bank = {\prod }_{i = 0}^{i \leq Positon number of rearmost dimension where there is a difference between orders} {F}_{{d}_{i}} \qquad [ Formula 6 ]$$

As a specific example, a case will be considered where the output order is w→h→c→n, the input order is c→w→h→n, and the array size is (w, h, c, n)=(32, 64, 16, 128). In this case, the rearmost dimension where there is a difference between the orders is the third dimension from the beginning (output order c, input order h). The amount of memory that can store all array elements indicated by this dimension and the dimensions preceding this dimension, w, h, and c, is (32×64×16)=32768. Therefore, the size of one bank is 32768 in this example.

Next, the IF specification formulation unit 120 compares the calculated amount of memory with twice the array size, and if the amount of memory is equal to or greater than (array size×2), the amount of memory, the size of one bank, and the number of buffer banks are changed as indicated below.

$$Amount of memory = Array size \times 2$$

Size of one bank=Array size
Number of buffer banks=2

If the amount of memory is smaller than (array size×2), the IF specification formulation unit 120 does nothing regarding the amount of memory, the size of one bank, and the number of buffer banks.

Next, the IF specification formulation unit 120 sets the calculated values as the parameters in the ping-pong buffer, as indicated below.
Amount of memory: amount of memory of the ping-pong buffer
Size of one bank: memory size of one bank in the ping-pong buffer
Number of buffer banks: number of memory banks in the ping-pong buffer

### DESCRIPTION OF EFFECTS OF EMBODIMENT 1

As described above, according to this embodiment, by providing the input/output information as input, the amount of memory of the IF part can be kept to not more than twice the array size not only for simple access patterns where, for example, access to a variable is expressed only by increment or decrement, but also for complex access patterns such as window access in image processing. In addition, according to this embodiment, by utilizing the input/output information, the IF part can be implemented as a data-driven circuit that is suitable for the access patterns of input and output variables and throughput, so that access control of the buffer memory in the IF part becomes relatively simple.

According to this embodiment, the IF part is implemented in the generation code 52 as a window buffer or a ping-pong buffer whose amount of memory is equal to or less than twice the array size, depending on the input/output information. Therefore, in a circuit generated based on the generation code 52, the circuit scale and the amount of memory can be reduced and the operating frequency of the circuit can also be improved compared to cases where existing technologies are used.

### Other Configurations

### Variation 1

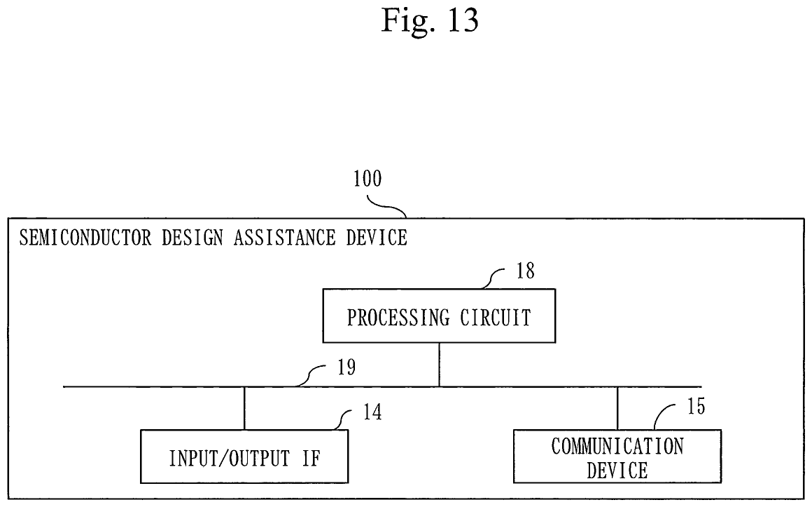

FIG. 13 illustrates an example of a hardware configuration of the semiconductor design assistance device 100 according to this variation.

The semiconductor design assistance device 100 includes a processing circuit 18 in place of the processor 11, in place of the processor 11 and the memory 12, in place of the processor 11 and the auxiliary storage device 13, or in place of the processor 11, the memory 12, and the auxiliary storage device 13.

The processing circuit 18 is hardware that realizes at least part of the units included in the semiconductor design assistance device 100.

The processing circuit 18 may be dedicated hardware, or may be a processor that executes programs stored in the memory 12.

When the processing circuit 18 is dedicated hardware, the processing circuit 18 is, as a specific example, a single circuit, a composite circuit, a programmed processor, a parallel-programmed processor, an application specific integrated circuit (ASIC), a field programmable gate array (FPGA), or a combination of these.

The semiconductor design assistance device 100 may include a plurality of processing circuits as an alternative to the processing circuit 18. The plurality of processing circuits share the role of the processing circuit 18.

In the semiconductor design assistance device 100, some functions may be realized by dedicated hardware, and the remaining functions may be realized by software or firmware.

As a specific example, the processing circuit 18 is realized by hardware, software, firmware, or a combination of these.

The processor 11, the memory 12, the auxiliary storage device 13, and the processing circuit 18 are collectively called “processing circuitry”. That is, the functions of the functional constituent elements of the semiconductor design assistance device 100 are realized by the processing circuitry.

### Other Embodiments

Embodiment 1 has been described, and portions of this embodiment may be implemented in combination. Alternatively, this embodiment may be partially implemented. Alternatively, this embodiment may be modified in various ways as necessary, and may be implemented as a whole or partially in any combination.

The embodiment described above is an essentially preferable example, and is not intended to limit the present disclosure as well as the applications and scope of uses of the present disclosure. The procedures described using the flowcharts or the like may be modified as appropriate.

### REFERENCE SIGNS LIST

11: processor, 12: memory, 13: auxiliary storage device, 14: input/output IF, 15: communication device, 18: processing circuit, 19: signal line, 51: source code, 52: generation code, 100: semiconductor design assistance device, 110: data flow analysis unit, 120: IF specification formulation unit, 121: function library, 130: IF generation unit, 131: IF template group.

1. A semiconductor design assistance device comprising
processing circuitry to refer to input/output information that indicates definitions of an access pattern and throughput for each input and each output of each of two functions, and formulate a specification of an interface part that transmits data between the two functions, based on source code that indicates the two functions and a data flow between the two functions indicated in the source code, the two functions being functions in each of which, when data is exchanged between two circuit modules, processing to be performed by a corresponding one of the two circuit modules is defined in a language that can define an input to and an output from a function.

2. The semiconductor design assistance device according to claim 1,
wherein the input/output information indicates at least one unfixed item that is an item that is not fixed until the source code is given, and
wherein the processing circuitry fixes each of the at least one unfixed item based on the source code.

3. The semiconductor design assistance device according to claim 1,
wherein when among the two functions, a function defined to be executed earlier in the source code is defined as a preceding function and a function defined to be executed later in the source code is defined as a succeeding function,
the processing circuitry determines an architecture of the interface part based on an output order of a target array indicated by the preceding function and an input order of the target array indicated by the succeeding function.

4. The semiconductor design assistance device according to claim 3,
wherein the processing circuitry selects a window buffer or a ping-pong buffer as the architecture.

5. The semiconductor design assistance device according to claim 1,
wherein the processing circuitry determines an amount of memory of the interface part based on the source code and the input/output information.

6. The semiconductor design assistance device according to claim 1,
wherein the processing circuitry generates source code that represents the interface part based on the formulated specification and a template of the interface part.

7. A semiconductor design assistance method comprising
referring to input/output information that indicates definitions of an access pattern and throughput for each input and each output of each of two functions, and formulating a specification of an interface part that transmits data between the two functions, based on source code that indicates the two functions and a data flow between the two functions indicated in the source code, the two functions being functions in each of which, when data is exchanged between two circuit modules, processing to be performed by a corresponding one of the two circuit modules is defined in a language that can define an input to and an output from a function, by a computer.

8. A non-transitory computer readable medium storing a semiconductor design assistance program that causes a semiconductor design assistance device, which is a computer, to execute
an interface specification formulation process of referring to input/output information that indicates definitions of an access pattern and throughput for each input and each output of each of two functions, and formulating a specification of an interface part that transmits data between the two functions, based on source code that indicates the two functions and a data flow between the two functions indicated in the source code, the two functions being functions in each of which, when data is exchanged between two circuit modules, processing to be performed by a corresponding one of the two circuit modules is defined in a language that can define an input to and an output from a function.
